(19) United States
(12) Patent Application Publication
(10) Pub. No.: US 2021/0036284 A1
(43) Pub. Date: Feb. 4, 2021

(54) BATTERY HOUSING FOR AT LEAST ONE BATTERY CELL HAVING A CERAMIC OR GLASS-LIKE OR METALLIC PROTECTIVE COATING, AND MOTOR VEHICLE

(71) Applicant: AUDI AG, Ingolstadt (DE)

(72) Inventors: Martin SCHÜSSLER, Kosching (DE); Lars KRUSE, Ingolstadt (DE)

(73) Assignee: AUDI AG, Ingolstadt (DE)

(21) Appl. No.: 16/936,833

(22) Filed: Jul. 23, 2020

(30) Foreign Application Priority Data
Aug. 1, 2019 (DE) 10 2019 211 528.4

(51) Int. Cl. H01M 2/12; H01M 2/02

(52) U.S. Cl. CPC H01M 2/1241; H01M 2002/0297; H01M 2220/20; H01M 2/0285

(57) ABSTRACT

A housing for at least one battery cell of an electrical energy accumulator of an at least partially electrically operated motor vehicle, having an interior of the battery housing, which is designed for arranging the at least one battery cell, and having at least one protective coating formed on at least one housing wall of the battery housing and facing toward the interior, wherein the protective coating is ceramic or glass-like or metallic and is designed to generate a degassing flow in the event of degassing of the battery cell from the interior of the battery housing. The disclosure furthermore relates to a motor vehicle.

### FIELD

The disclosure relates to a battery housing for at least one battery cell of an electrical energy accumulator of an at least partially electrically operated motor vehicle, having an interior of the battery housing, which is designed for arranging the at least one battery cell, and having at least one protective coating formed on at least one housing wall of the battery housing and facing toward the interior. The disclosure furthermore relates to a motor vehicle.

### BACKGROUND

Battery systems which have a fire protection concept for the case of cell degassing are known from the present prior art. This is to be used to damage further battery cells and to protect the motor vehicle and its occupants. During cell degassing, gases are released at high temperatures and can possibly ignite. Housing components and battery cells can be exposed to these gases and can be damaged. Is known for this purpose that fire protection presently requires the introduction of separate materials, for example, climate mats, in order to ensure the fire protection.

DE 10 2013 201 026 A1 discloses a method and a device for producing a coated housing or housing element, in particular a battery cell housing or battery cell housing element, wherein in the method a surface of the housing or housing element is at least partially coated using coating material and a property of the coating material is changed by means of irradiation by a laser beam.

Furthermore, DE 10 2014 201 539 A1 relates to a battery housing, which forms a receptacle space for accommodating an electrode unit having an anode, a cathode, a separator arranged in between, and an electrolyte, which is liquid in particular, wherein an electrically insulated layer is arranged on the surface of the battery housing facing in the direction of the receptacle space, wherein the electrically insulated layer is formed from a glass material.

Furthermore, DE 10 2012 222 876 A1 discloses an electrochemical energy accumulator. The energy accumulator comprises a cell space for at least partially accommodating an anode and a cathode, wherein the cell space is at least partially separated by a housing from the external environment, and wherein the energy accumulator is at least partially provided with a coating, wherein the coating can be foamed by heat action.

A disadvantage of the prior art is that the housing component and battery cells are not designed to be directly exposed to the degassing cell and a corresponding thermal load. This means that either separate fire protection measures are necessary or fire protection is restricted. Moreover, a further ignition of a cell can occur. These additional measures take up installation space and increase the manufacturing steps.

### SUMMARY

The object of the present invention is to provide a battery housing and a motor vehicle, by means of which the safety within the battery housing can be increased.

This object is achieved by a battery housing and a motor vehicle according to the independent claims. Advantageous embodiments are specified in the dependent claims.

One aspect of the invention relates to a battery housing for at least one battery cell of an electrical energy accumulator of an at least partially electrically operated motor vehicle, having an interior of the battery housing, which is designed for arranging the at least one battery cell, and having at least one protective coating formed on at least one housing wall of the battery housing and facing toward the interior.

It is provided that the protective coating is ceramic or glass-like or metallic and is designed to generate a degassing flow from the interior of the battery housing in the event of degassing of the battery cell.

This enables the application of the protective coating, in particular the ceramic or glass-like or metallic protective coating, to implement a temperature-resistant and chemical-resistant coating of the housing wall. In particular, for example, the housing wall, which is made of light metal, can thereby be better protected and thus separate fire protection measures can be reduced. The housing wall having the protective coating is thus in particular designed to discharge the escaping gas in the event of degassing of the battery cell. The fire protection or the safety concept of the battery housing can thus be improved.

In particular, the invention thus provides that the at least one housing wall of the battery housing, which is subjected to high temperatures directly from the degassing battery cell in the event of degassing of the battery cell, is completely or partially covered with a protective coating made of ceramic or glass or metal. In particular, the metal as a protective coating has a different, in particular a higher, melting point than, for example, a housing wall. For example, a steel sheet can be arranged as a protective coating on a housing wall made of aluminum.

According to one advantageous embodiment, the battery housing has a degassing opening, which is designed to discharge the degassing flow from the interior into an environment of the battery housing. In other words, the protective coating is designed in such a way that the degassing flow is diverted toward the degassing opening. The resulting gas, in the event of the degassing of the battery cell, can then in turn be discharged through the degassing opening into the environment of the battery housing. This can prevent overheating from occurring within the battery housing, whereby in particular the battery housing is protected from further destruction or further battery cells inside the battery housing are protected from further destruction.

According to a further advantageous embodiment, the degassing opening has a bursting membrane, which is designed to burst in the event of a degassing pressure present in the interior and to discharge the degassing flow into the environment. In other words, with an intact battery cell, the battery housing is separated from the environment and in particular is protected from environmental influences. If degassing of the battery cell is then to occur, the bursting membrane is thus caused to burst in dependence on the resulting degassing pressure. The degassing flow can then escape from the battery housing only when the predetermined degassing pressure is exceeded. This makes it possible for the battery cell to be protected from environmental influences in the intact state of the battery cell. In the event of degassing of the battery cell, the corresponding degassing flow is then discharged from the battery housing into the environment.

Furthermore, it has proven to be advantageous if the battery housing has an additional degassing element which is designed to be arranged between the battery cell and at least one housing wall in the interior. By using the degassing element, an additional component can thus be provided within the battery housing, which component is formed independently of the housing wall and separately from the housing wall. The degassing flow can additionally be guided through the degassing element, and in particular can be guided in an improved manner to a degassing opening. This can prevent the housing wall from coming into direct contact with the degassing flow, whereby temperature protection can be implemented for the housing wall. Furthermore, an improved discharge of the degassing flow can be implemented by means of the degassing element.

In a further advantageous embodiment, the degassing element is angled at a first end of the degassing element and/or at a second end of the degassing element opposite to the first end. In particular, the degassing element is angled such that it is arranged above a degassing opening of the battery cell and covers this degassing opening in particular in a roof-like manner. This makes it possible for the degassing flow, which in particular can flow out of the degassing opening of the battery cell, to be reliably discharged. This allows less heat and gas to be generated inside the battery housing. A direct discharge of the degassing flow can thus be implemented.

Furthermore, it has proven to be advantageous if the at least one coated housing wall is opposite to at least one degassing device of the battery cell. In particular, the battery cell itself can also have a degassing device. The degassing device of the battery cell can be designed, for example, as a bursting membrane. If degassing of the battery cell should then occur, the gas thus escapes from the degassing device of the battery cell. Because the coated housing wall is then again opposite to this degassing device, this housing wall is protected from the high temperatures or the gas materials arising in this case. In particular, in the embodiment having the degassing element, the degassing element can be opposite to the degassing device and in particular can be arranged between the housing wall and the degassing device. The protective coating can thus be provided on a reduced number of components, in particular solely on the opposing housing wall.

Furthermore, it has proven to be advantageous if the battery housing is made of aluminum. In particular, a light battery housing can thereby be provided. The aluminum can nonetheless be reliably protected from excessively high temperatures by the protective coating. A safe and nonetheless light battery housing is thus enabled.

In a further advantageous embodiment, the protective coating is dimensionally stable in the event of degassing of the battery cell. In other words, there is no change in the shape of the protective coating during degassing. In particular, the protective coating thus does not swell. This makes it possible to provide less space for the protective coating within the battery housing. Thus, the battery case can be made smaller.

It is furthermore advantageous if a cover element of the battery housing and/or a first side element of the battery housing and/or a second side element of the battery housing and/or a base element of the battery housing has the protective coating. In particular, the cover element and the first side element and the second side element and the base element, which is in particular opposite the first side element, are thus formed having the protective coating. Reliable protection is thus implemented in the event of degassing of the battery cell.

A further aspect of the invention relates to a motor vehicle having a battery housing according to the preceding aspect.

The motor vehicle according to the invention is preferably designed as an automobile, in particular as a passenger car or truck, or as a passenger bus or motorcycle.

The disclosure also comprises the combinations of the features of the described embodiments.

### BRIEF DESCRIPTION OF THE DRAWINGS

Exemplary embodiments of the invention are described hereinafter. In the figures:

FIG. 1 shows a schematic side view of an embodiment of a battery housing; and

FIG. 2 shows a further schematic side view of a further embodiment of the battery housing.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is intended to comprise combinations of the features of the embodiments other than those shown. Furthermore, the described embodiments can also be supplemented by further features of the invention that have already been described.

In the figures, the same reference numerals designate elements that have the same function.

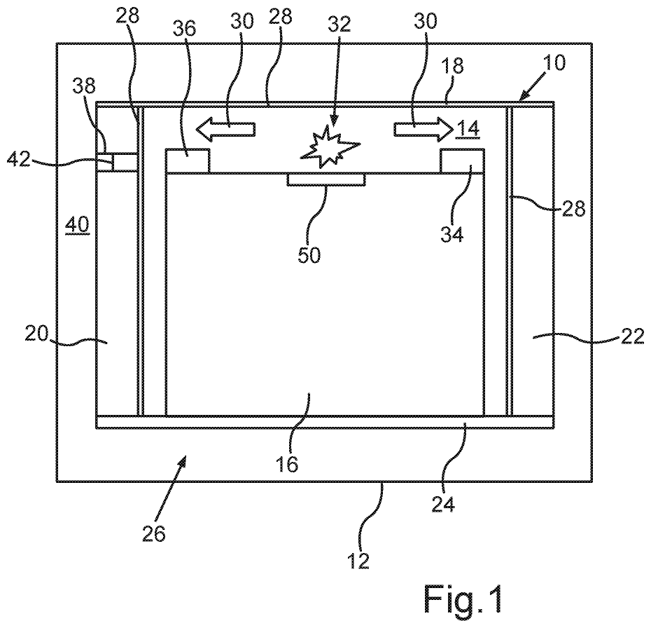

FIG. 1 shows a schematic side view of an embodiment of a battery housing 10. In the present exemplary embodiment, the battery housing 10 is embodied, in particular, purely schematically in a motor vehicle 12 shown purely schematically. The battery housing 10 has an interior 14. In particular, a battery cell 16 can be arranged in the interior 14. In the present exemplary embodiment, the battery cell 16 is arranged in the interior 14.

In the present exemplary embodiment, the battery housing 10 has, in particular, a cover element 18, a first side element 20, and a second side element 22. Furthermore, the battery housing 10 has a base element 24.

The battery housing 10 is designed for the at least one battery cell 16 of an electrical energy accumulator 26 of the at least partially electrically operated motor vehicle 12. In particular, the electrical energy accumulator 26 can be formed from a plurality of battery cells 16. For this purpose, the electrical energy accumulator 26 can have a plurality of battery housings 10, wherein each of the battery housings 10 can in turn have a plurality of battery cells 16. In particular, the battery housing can thus be formed as part of a battery module, wherein the electrical energy accumulator 26 can in turn have a large number of battery modules. The battery housing 10 has the interior 14, which is formed for the arrangement of the at least one battery cell 16. Furthermore, the battery housing 10 has a first housing wall 18, 20, 22, 24. In the present exemplary embodiment, the housing walls 18, 20, 22, 24 are formed in particular by the cover element 18, by the first side wall 20, by the second side wall 22, and by the base element 24.

In particular, the battery housing 10 has a protective coating 28 facing toward the interior 14. In the present exemplary embodiment, in particular the cover element 18 has the protective coating 28, the first side element 20 has the protective coating 28, and the second side element 22 has the protective coating 28.

It is provided that the protective coating 28 is ceramic or glass-like or metallic and is designed to generate a degassing flow 30 in the event of degassing 32 of the battery cell 16 from the interior 14 of the battery housing 10.

In the present exemplary embodiment, it is shown in particular that the battery cell 16 can have an anode 34 and a cathode 36. FIG. 1 also shows that the battery cell 16 can have a degassing device 50. The degassing device 50 is, in particular, designed to selectively guide the resulting gas from the battery cell during the degassing 32 of the battery cell 16. In particular, it is then provided that the at least one coated housing wall, in the present exemplary embodiment the coated cover element 18, is at least opposite to the degassing device 50 of the battery cell 16.

Furthermore, FIG. 1 shows that the battery housing 10 can have a degassing opening 38, which is designed to discharge the degassing flow 30 from the interior 14 into an environment 40 of the battery housing 10. For this purpose, for example, it can be provided that the degassing opening 38 has a bursting membrane 42, which is designed to burst in the event of a predetermined degassing pressure in the interior 14 and to discharge the degassing flow 30 into the environment 40.

In particular, FIG. 1 furthermore shows that the cover element 18 and/or the first side element 20 and/or the second side element 22 can have the protective coating 18.

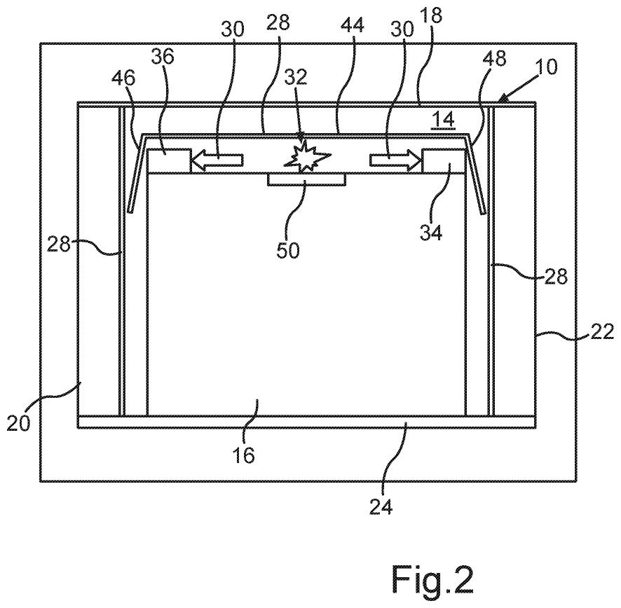

FIG. 2 shows a schematic side view of a further embodiment of the battery housing 10. In the present exemplary embodiment, it is shown in particular that the battery housing 10 can have an additional degassing element 44, which is designed to be arranged between the battery cell 16 and at least one housing wall 18, 20, 22, 24, in the present exemplary embodiment between the battery cell 16 and the cover element 18, in the interior 14. In particular, it can be provided for this purpose that the degassing element 44 is angled at a first end 46 and/or at a second end 48 opposite to the first end 46. The degassing flow 30 can thus be discharged in an improved manner. In particular, it can be provided for this purpose that the degassing element 44 can have the protective coating 28. In particular, it is then apparent in the present exemplary embodiment that the cover element 18 does not have a protective coating 28, since the cover element 18 is already protected from the degassing 32 by the degassing element 44. The degassing element 44 is arranged in the present case between the degassing device 50 and the cover element 18 and thus protects the cover element 18.

In particular, it can furthermore be provided that the battery housing 10 is made of aluminum. In particular, a light battery housing 10 can thereby be provided. Appropriate fire protection can be implemented by the protective coating 28.

Furthermore, it can in particular be provided that the protective coating 28 is dimensionally stable during the degassing 32 of the battery cell 16.

In particular, it is thus shown that the application of the temperature-resistant and chemical-resistant protective coating 28 of the battery housing 10 can improve the temperature resistance, in particular of light metals which form the battery housing 10, and thus separate fire protection measures can be reduced. In addition, the housing components can be used to selectively discharge the gas escaping from the battery cell 16. The fire protection and safety concept of the battery housing 10 can thus be improved.

In particular, it can be provided for this purpose that the housing components or further components, which in the case of degassing 32 are directly exposed to high temperatures by the degassing battery cell 16, are completely or only partially covered using a resistant coating, in other words the protective coating 28. In addition, the housing components can be actively used for the selective discharge of the gases. A glass-like or ceramic or metallic protective coating 28 can in particular be used to protect the surface.

Overall, the invention discloses an integrated and partial protective coating 28 of battery housing components to protect the battery housing 10.

1. A battery housing comprising:
at least one battery cell of an electrical energy accumulator of an at least partially electrically operated motor vehicle, having an interior of the battery housing, which is designed for arranging the at least one battery cell, and having at least one protective coating formed on at least one housing wall of the battery housing and facing toward the interior, and
the protective coating is ceramic or glass-like or metallic and is designed to generate a degassing flow in the event of degassing of the battery cell from the interior of the battery housing.

2. The battery housing as claimed in claim 1, wherein the battery housing has a degassing opening, which is designed to discharge the degassing flow from the interior into an environment of the battery housing.

3. The battery housing as claimed in claim 2, wherein the degassing opening has a bursting membrane, which is designed to burst in the event of a predetermined degassing pressure in the interior and to discharge the degassing flow into the environment.

4. The battery housing as claimed in claim 1, wherein the battery housing has an additional degassing element which is designed to be arranged between the battery cell and at least one housing wall in the interior.

5. The battery housing as claimed in claim 4, wherein the degassing element is angled at a first end of the degassing element and/or at a second end of the degassing element opposite to the first end.

6. The battery housing as claimed in claim 1, wherein the at least one coated housing wall is opposite to at least one degassing device of the battery cell.

7. The battery housing as claimed in claim 1, wherein the battery housing is made of aluminum.

8. The battery housing as claimed in claim 1, wherein the protective coating is dimensionally stable during degassing of the battery cell.

9. The battery housing as claimed in claim 1, wherein a cover element of the battery housing and/or a first side element of the battery housing and/or a second side element of the battery housing and/or a base element of the battery housing has the protective coating.

10. The battery housing as claimed in claim 2, wherein the protective coating is dimensionally stable during degassing of the battery cell.

11. The battery housing as claimed in claim 3, wherein the protective coating is dimensionally stable during degassing of the battery cell.

12. The battery housing as claimed in claim 4, wherein the protective coating is dimensionally stable during degassing of the battery cell.

13. The battery housing as claimed in claim 5, wherein the protective coating is dimensionally stable during degassing of the battery cell.

14. The battery housing as claimed in claim 6, wherein the protective coating is dimensionally stable during degassing of the battery cell.

15. The battery housing as claimed in claim 7, wherein the protective coating is dimensionally stable during degassing of the battery cell.

16. The battery housing as claimed in claim 2, wherein a cover element of the battery housing and/or a first side element of the battery housing and/or a second side element of the battery housing and/or a base element of the battery housing has the protective coating.

17. The battery housing as claimed in claim 3, wherein a cover element of the battery housing and/or a first side element of the battery housing and/or a second side element of the battery housing and/or a base element of the battery housing has the protective coating.

18. The battery housing as claimed in claim 4, wherein a cover element of the battery housing and/or a first side element of the battery housing and/or a second side element of the battery housing and/or a base element of the battery housing has the protective coating.

19. The battery housing as claimed in claim 5, wherein a cover element of the battery housing and/or a first side element of the battery housing and/or a second side element of the battery housing and/or a base element of the battery housing has the protective coating.

20. The battery housing as claimed in claim 6, wherein a cover element of the battery housing and/or a first side element of the battery housing and/or a second side element of the battery housing and/or a base element of the battery housing has the protective coating.
